(19) United States
(12) Patent Application Publication
(10) Pub. No.: US 2026/0067580 A1
(43) Pub. Date: Mar. 5, 2026

(54) IMAGE PROCESSING METHOD AND APPARATUS AND IMAGE SHOOTING METHOD AND APPARATUS

(71) Applicant: HANWHA VISION CO, LTD., Seongnam-si (KR)

(72) Inventor: Chang Min LEE, Seongnam-si (KR)

(73) Assignee: HANWHA VISION CO, LTD., Seongnam-si (KR)

(21) Appl. No.: 19/076,465

(22) Filed: Mar. 11, 2025

(30) Foreign Application Priority Data
Sep. 4, 2024 (KR) 10-2024-0120315

(51) Int. Cl. H04N 23/741; G06T 7/246; H04N 23/72; H04N 23/73; H04N 23/743

(52) U.S. Cl. CPC H04N 23/741; G06T 7/246; H04N 23/72; H04N 23/73; H04N 23/743

(57) ABSTRACT

Provided is an image processing method including generating motion data for a pixel included in each of one or more channels configured to use motion masks having different sizes, the channels being included in at least a portion of an output image, generating one or more motion maps based on a difference between motion data the one or more channels for motion masks having a same size, determining a reference motion map among the one or more motion maps for each pixel included in the output image, determining a composition ratio of the one or more channels to be used for each pixel included in the output image based on a motion value on the reference motion map, and generating the output image based on the composition ratio of the one or more channels.

### CROSS-REFERENCE TO RELATED APPLICATION

This application claims priority to Korean Patent Application No. 10-2024-0120315, filed on Sep. 4, 2024, in the Korean Intellectual Property Office, the disclosure of which is incorporated by reference herein in its entirety.

### BACKGROUND

### 1. Field

Embodiments of the present disclosure relate to an image processing method and apparatus for expanding a dynamic range of an output image by partially synthetizing one or more channels and an image shooting method and apparatus.

### 2. Description of Related Art

Recently, wide dynamic range (WDR) and high dynamic range (HDR) shooting methods have been used for various purposes. Such shooting methods may expand the dynamic range of an output image by continuously shooting and synthesizing a short exposure image and a long exposure image. Therefore, these shooting methods are particularly effective in scenes with a very high contrast ratio, such as a backlight environment.

However, the shooting methods cause double images such as motion blur in the case of a moving object due to a difference in shooting time between two images being synthesized. To solve this problem, according to related techniques, a method of shortening the shooting time of long exposure images has been used. However, this method requires the use of a high digital gain to overcome a short exposure time, which leads to increasing noise in the entire image.

### SUMMARY

One or more embodiments provides an image processing method capable of effectively reducing noise in a motion region while minimizing motion artifacts in an image generated by merging one or more channels.

According to an aspect of one or more embodiments, there is provided an image processing method including generating motion data for a pixel included in each of one or more channels configured to use motion masks having different sizes, the channels being included in at least a portion of an output image, generating one or more motion maps based on a difference between motion data the one or more channels for motion masks having a same size, determining a reference motion map among the one or more motion maps for each pixel included in the output image, determining a composition ratio of the one or more channels to be used for each pixel included in the output image based on a motion value on the reference motion map, and generating the output image based on the composition ratio of the one or more channels.

The one or more channels may include a first channel acquired based on a first exposure for a first scene, a second channel acquired based on a second exposure for the first scene, and a third channel acquired based on a third exposure for the first scene, wherein a size of the second exposure is less than a size of the first exposure, and a size of the third exposure is less than the size of the second exposure.

The motion masks may include a first mask configured to generate motion data of a target pixel based on characteristics of the target pixel and I pixels adjacent to the target pixel, where I is a natural number, and a second mask configured to generate motion data of the target pixel based on the characteristics of the target pixel and J pixels adjacent to the target pixel, where J is a natural number greater than I.

The generating of the one or more motion maps may include generating a motion map including a difference between motion data based on a first motion mask for a first comparison target channel per pixel and motion data based on the first motion mask for a second comparison target channel.

The one or more channels may include a first channel obtained based on a first exposure for a first scene, a second channel obtained based on a second exposure for the first scene, and a third channel obtained based on a third exposure for the first scene, wherein a size of the second exposure is less than a size of the first exposure, and a size of the third exposure is less than the size of the second exposure, and wherein the determining of the reference motion map may include determining the reference motion map based on at least one of the size of the first exposure of the first channel, the size of the second exposure of the second channel, the size of the third exposure of the third channel, a gain value of the first channel, a gain value of the second channel, a gain value of the third channel, a brightness per pixel of the first channel, a brightness per pixel of the second channel, and a brightness per pixel of the third channel.

The determining of the reference motion map may include determining a third reference motion map among one or more first motion maps generated based on a difference in motion data of the first channel and motion data of the second channel, determining a fourth reference motion map among one or more second motion maps generated based on a difference in motion data of the second channel and motion data of the third channel, and determining one of the third reference motion map and the fourth reference motion map as the reference motion map based on the brightness per pixel of the one or more channels.

The determining of the third reference motion map may include obtaining a first weight based on a difference between the first exposure and the second exposure at a position corresponding to a first pixel included in the output image, obtaining a second weight based on a size of the first exposure at the position corresponding to the first pixel, obtaining a third weight based on a gain of the second channel, and determining the third reference motion map based on the first weight, the second weight, and the third weight, wherein the determining of the third reference motion map includes determining the third reference motion map based on data in which a size of a motion mask used for generating a motion map is mapped for each weight.

The determining of the fourth reference motion map may include obtaining a fourth weight based on a difference between the second exposure and the third exposure at a position corresponding to a first pixel included in the output image, obtaining a fifth weight based on the size of the second exposure at the position corresponding to the first pixel, obtaining a sixth weight based on a gain of the third channel, obtaining a seventh weight based on a difference between the first exposure and the second exposure at the position corresponding to the first pixel, and determining the fourth reference motion map based on the fourth weight, the fifth weight, the sixth weight, and the seventh weight, wherein the determining of the fourth reference motion map include data in which a size of a motion mask used for generating a motion map is mapped for each weight.

The determining of one of the third reference motion map and the fourth reference motion map as the reference motion map may include determining the third reference motion map as the reference motion map based on the brightness of a first pixel being less than a predetermined threshold value, and determining the fourth reference motion map as the reference motion map based on the brightness of the first pixel is greater than the predetermined threshold value.

The determining of the composition ratio may include determining the composition ratio of the channels for each pixel included in the output image based on data in which the composition ratio of each channel among the channels is mapped for each motion value, and wherein the generating of the output image may include generating the output image by merging the one or more channels based on the composition ratio.

According to another aspect of one or more embodiments, there is provided an image shooting method for expanding a dynamic range by partial synthesis of one or more channels, the image shooting method including obtaining images of the one or more channels having different exposure sizes, generating motion data for a pixel included in the one or more channels configured to use motion masks having different sizes, the one or more channels being included in at least a portion of an output image, generating one or more motion maps based on a difference in motion data between the one or more channels for motion masks having a same size, determining a reference motion map among the one or more motion maps for each pixel included in the output image, determining a composition ratio of the one or more channels to be used for each pixel included in the output image based on a motion value on the reference motion map, and generating the output image based on the composition ratio of the one or more channels.

According to still another aspect of one or more embodiments, there is provided an image processing apparatus including a memory storing computer code or instructions, and a processor, when executing the computer code or instructions, configured to generate motion data for a pixel included in each of one or more channels configured to use motion masks having different sizes, the one or more channels being included in at least a portion of an output image, generate one or more motion maps based on a difference in motion data between the one or more channels for motion masks having a same size, determine a reference motion map among the one or more motion maps for each pixel included in the output image, determine a composition ratio of the one or more channels to be used for each pixel included in the output image based on a motion value on the reference motion map, and generate the output image based on the composition ratio of the one or more channels.

The one or more channels may include a first channel obtained based on a first exposure for a first scene, a second channel obtained based on a second exposure for the first scene, and a third channel obtained based on a third exposure for the first scene, wherein a size of the second exposure is less than a size of the first exposure, and a size of the third exposure is less than the size of the second exposure.

The motion masks may include a first mask configured to generate motion data of a target pixel based on characteristics of the target pixel and I pixels adjacent to the target pixel, where I is a natural number, and a second mask configured to generate motion data of the target pixel based on the characteristics of the target pixel and J pixels adjacent to the target pixel, where J is a natural number greater than I.

The processor may be further configured to, in generating the one or more motion maps, generate a motion map including a difference between motion data based on a first motion mask for a first comparison target channel and motion data based on the first motion mask for a second comparison target channel per pixel.

The one or more channels may include a first channel obtained based on a first exposure for a first scene, a second channel obtained based on a second exposure for the first scene, and a third channel obtained based on a third exposure for the first scene, wherein a size of the second exposure is less than a size of the first exposure, and a size of the third exposure is less than the size of the second exposure, and wherein the processor may be further configured to, in determining a motion map to be referenced, determine the reference motion map among the one or more motion maps based on at least one of the size of the first exposure of the first channel, the size of the second exposure of the second channel, the size of the third exposure of the third channel, a gain value of the first channel, a gain value of the second channel, a gain value of the third channel, a brightness per pixel of the first channel, a brightness per pixel of the second channel, and a brightness per pixel of the third channel.

The processor, in determining the reference motion map, may be further configured to determine a third reference motion map among one or more first motion maps generated based on a difference in motion data of the first channel and motion data of the second channel, determine a fourth reference motion map among one or more second motion maps generated based on a difference in motion data of the second channel and motion data of the third channel, and determine one of the third reference motion map and the fourth reference motion map as the reference motion map based on the brightness per pixel of the one or more channels.

The processor, in determining the third reference motion map, may be further configured to obtain a first weight based on a difference between the first exposure and the second exposure at a position corresponding to a first pixel included in the output image, obtain a second weight based on the size of the first exposure at the position corresponding to the first pixel, obtain a third weight based on a gain of the second channel, and determine the third reference motion map based on the first weight, the second weight, and the third weight, wherein the third reference motion map is determined based on data in which a size of a motion mask used for generating the motion map is mapped for each weight.

The processor, in determining the fourth reference motion map, may be further configured to obtain a fourth weight based on a difference between the second exposure and the third exposure at a position corresponding to a first pixel included in the output image, obtain a fifth weight based on the size of the second exposure at the position corresponding to the first pixel, obtain a sixth weight based on a gain of the third channel, obtain a seventh weight based on the difference between the first exposure and the second exposure at the position corresponding to the first pixel, and determine the fourth reference motion map based on the fourth weight, the fifth weight, the sixth weight, and the seventh weight, wherein the fourth reference motion map is determined based on data in which a size of a motion mask used for generating the motion map is mapped for each weight.

The processor may be further configured to determine the third reference motion map as the reference motion map when the brightness of a first pixel is less than a predetermined threshold value and determine the fourth reference motion map as the reference motion map when the brightness of the first pixel is greater than the predetermined threshold value.

The processor may be further configured to determine the composition ratio of the channels for each pixel of the output image based on data in which the composition ratio of each channel is mapped to each motion value and generate the output image by merging the one or more channels based on the composition ratio.

According to still another aspect of one or more embodiments, there is provided an image shooting apparatus configured to expand a dynamic range by partial synthesis of one or more channels, the image shooting apparatus being configured to obtain images of the channels having different exposure sizes, generate motion data for a pixel included in each of the one or more channels configured to use motion masks having different sizes, the channels being included in at least a portion of an output image, generate one or more motion maps based on a difference in motion data between the one or more channels for motion masks of a same size, determine a reference motion map among the one or more motion maps for each pixel included in the output image, determine a composition ratio of the one or more channels to be used for each pixel included in the output image based on a motion value on the reference motion map, and generate the output image based on the composition ratio of the one or more channels.

### BRIEF DESCRIPTION OF DRAWINGS

The above and other aspects, features, and advantages of embodiments of the disclosure will be more apparent from the following description taken in conjunction with the accompanying drawings, in which:

FIG. 1 is a schematic diagram illustrating a configuration of an image processing apparatus according to one or more embodiments;

FIG. 2 is a diagram for explaining a channel according to one or more embodiments;

FIG. 3 is a diagram for explaining a motion mask according to one or more embodiments;

FIG. 4 is a diagram for explaining an example motion data set;

FIG. 5 is a diagram for explaining a process of generating a motion map by a processor according to one or more embodiments;

FIG. 6 is a diagram for explaining a process of determining, by a processor, a motion map to be referenced for each pixel included in an output image according to one or more embodiments;

FIG. 7 is a diagram illustrating a graph for calculating a first weight by a processor according to one or more embodiments;

FIG. 8 is a diagram illustrating a graph for calculating a second weight by a processor according to one or more embodiments;

FIG. 9 is a diagram illustrating a graph for calculating a third weight by a processor according to one or more embodiments;

FIG. 10 is a diagram illustrating data on which a size of a motion mask for generating a motion map by weight is mapped according to one or more embodiments;

FIG. 11 is a diagram illustrating a graph for calculating a fourth weight by a processor according to one or more embodiments;

FIG. 12 is a diagram illustrating a graph for calculating a fifth weight by a processor according to one or more embodiments;

FIG. 13 is a diagram illustrating a graph for calculating a sixth weight by a processor according to one or more embodiments;

FIG. 14 is a diagram illustrating a graph for calculating a seventh weight by a processor according to one or more embodiments; and

FIG. 15 is a flowchart of an image processing method performed by a processor according to one or more embodiments.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. For example, an expression, “at least one of a, b, and c” should be understood as including only a, only b, only c, both a and b, both a and c, both b and c, or all of a, b, and c.

The disclosure may be modified into various forms and may have various embodiments. In these regards, embodiments will be described, examples of which are illustrated in the accompanying drawings. The advantages, features, and methods of achieving the advantages may be clear when referring to the embodiments described below together with the drawings. However, the disclosure may have different forms and should not be construed as being limited to the descriptions set forth herein.

Hereafter, the disclosure will be described more fully with reference to the accompanying drawings, in which embodiments of the disclosure are shown. In describing the disclosure with reference to drawings, like reference numerals are used for elements that are substantially identical or correspond to each other, and the descriptions thereof will not be repeated.

Although the terms “first”, “second”, “third”, etc., may be used herein to describe various elements, these elements should not be limited by these terms. These terms are only used to distinguish one element from another. In the following embodiments, the singular forms include the plural forms unless the context clearly indicates otherwise. The terms “comprises,” “comprising,” “includes,” and/or “including,” when used herein, specify the presence of stated features and/or constituent elements, but do not preclude the addition of one or more other features and constituent elements. In the drawings, thicknesses of layers and regions may be exaggerated or reduced for convenience of explanation. For example, sizes and thicknesses of elements in the drawings are arbitrarily expressed for convenience of explanation, and thus, embodiments are not limited to the drawings.

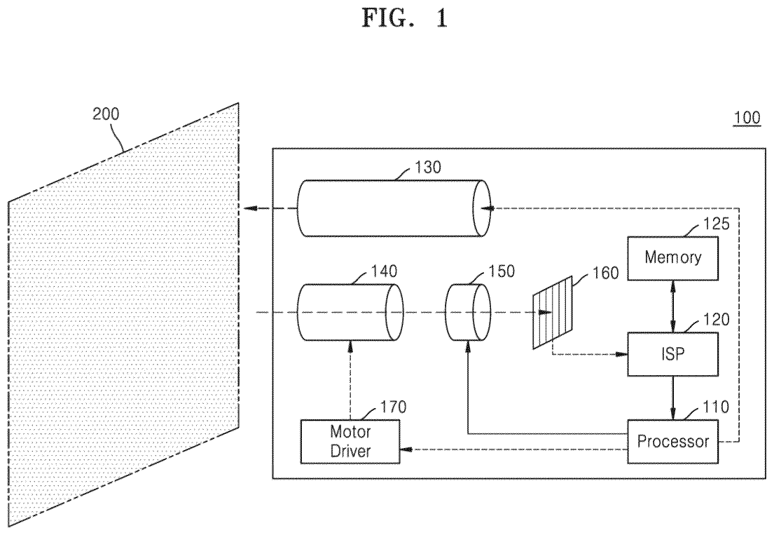

FIG. 1 is a schematic diagram illustrating a configuration of an image processing apparatus 100 according to one or more embodiments.

The image processing apparatus 100 according to one or more embodiments may generate an output image using one or more channels having different exposure sizes. At this time, the image processing apparatus 100 according to one or more embodiments may generate a motion map based on a difference in motion data between the channels and use the motion map to determine a composition ratio of the one or more channels to be used for each pixel of the output image.

The image processing apparatus 100 according to one or more embodiments may include a processor 110, an image signal processor (ISP) 120, a memory 125, a light source 130, a lens group 140, a filter group 150, an image sensor 160, and a motor driver 170 as illustrated in FIG. 1.

The processor 110 according to one or more embodiments may control the components of the image processing apparatus 100 by executing computer code or programs stored in the memory 125 which may be formed or a plurality of memory modules. The computer code or programs stored in the memory 125 may be loaded to an internal memory of the imaging processing apparatus 100 for execution to perform a plurality of functions or operations described herein. For example, the processor 110 may drive the motor driver 170 according to the user's operation to move the lens group 140 to an appropriate position. In addition, the processor 110 may appropriately recommend or select a shooting mode based on an image acquired by the image sensor 160. However, embodiments are not limited thereto.

In the present disclosure, a processor may denote, for example, a data processing apparatus having a physically structured circuit and built into hardware to perform a function expressed by a code or command included in a program. As an example, the data processing apparatus built into hardware may include a processing apparatus such as a microprocessor, a central processing unit (CPU), a processor core, a multiprocessor, an application-specific integrated circuit (ASIC), and a field programmable gate array (FPGA), but the scope of the disclosure is not limited thereto.

The processor 110 may be configured as a single processor, or may be configured as multiple processors that are divided into units of functions performed by the processor 110.

The ISP 120 and the image sensor 160 according to one or more embodiments may convert light (or an optical signal) into an electrical signal. For example, the image sensor 160 may be configured as a charge coupled device (CCD) or a complementary metal-oxide-semiconductor (CMOS) and may convert light passing through the lens group 140 and/or the filter group 150 into an electrical signal.

In addition, the ISP 120 may process an image (or an unprocessed RAW image) acquired by the image sensor 160 in a predetermined manner. For example, the ISP 120 may synthesize one or more channels acquired by the image sensor 160 to generate one output image.

In one or more embodiments, the ISP 120 and the image sensor 160 may be configured independently as shown in FIG. 1 or may be configured as integrated into one component. In addition, in one or more other embodiments, the ISP 120 and the processor 110 may be configured independently as shown in FIG. 1 or may be configured as integrated into one component.

The lens group 140 and the motor driver 170 according to one or more embodiments may perform operations for adjusting various parameters related to the image processing apparatus 100 under the control of the processor 110. For example, the lens group 140 and/or the motor driver 170 according to one or more embodiments may adjust the position of at least one lens to adjust the focus under the control of the processor 110. The lens group 140 may include at least one lens (or a single lens).

In addition, the lens group 140 and/or the motor driver 170 according to one or more embodiments may adjust the opening degree of an aperture according to the control of the processor 110.

In addition, the lens group 140 and/or the motor driver 170 according to one or more embodiments may adjust zoom according to the control of the processor 110. However, the parameters described above are examples and embodiments are not limited thereto.

The filter group 150 according to one or more embodiments may be is arranged between the lens group 140 and the image sensor 160 described above and may adjust the wavelength composition of incident light.

The light source 130 according to one or more embodiments may irradiate (emit) light for the image processing apparatus 100 to adjust a focus on a shooting region 200. In addition, the light source 130 may irradiate (emit) light for increasing illuminance of the shooting region 200 during a process of shooting an image. However, this is an example, and embodiments are not limited thereto.

In the present disclosure, a shooting region may denote a region that is a target of image acquisition. For example, the shooting region may denote a space that includes an object that is a target of image acquisition.

In the present disclosure, the image processing apparatus 100 may be referred to as a shooting apparatus.

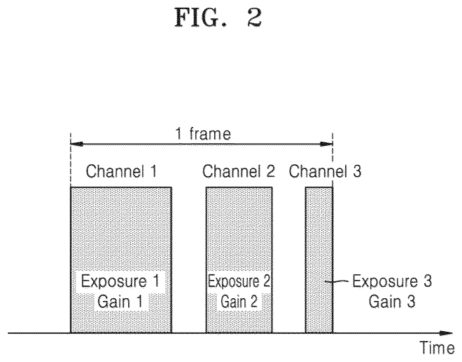

FIG. 2 is a diagram for explaining a channel according to one or more embodiments.

In the present disclosure, a channel may be an image used to generate one output image, and images captured of the same scene may be classified in the form of channels.

In one or more embodiments, as illustrated in FIG. 2, one or more channels may include a first channel Channel 1 acquired according to a first exposure Exposure 1, a second channel Channel 2 acquired according to a second exposure Exposure 2, and a third channel Channel 3 acquired according to a third exposure Exposure 3. In this case, all three channels may be images captured of the same first scene (Scene). Also, as shown, a size of the second exposure Exposure 2 may be less than a size of the first exposure Exposure 1, and a size of the third exposure Exposure 3 may be less than the size of the second exposure Exposure 2.

In the present disclosure, an exposure size may be an amount of light applied to a process of generating a corresponding channel, and may be determined based on various parameters. For example, the exposure size may be determined based on a length of exposure time. However, this is an example, and embodiments are not limited thereto.

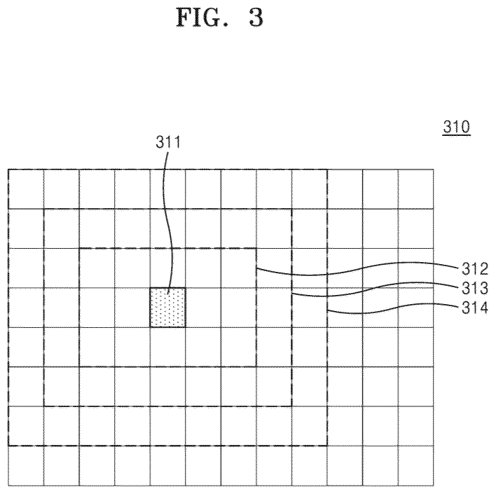

FIG. 3 is a diagram for explaining a motion mask according to one or more embodiments. Hereinafter, for convenience of explanation, mainly a target pixel 311 on an example channel 310 is described.

According to one or more embodiments, one or more motion masks may be used to generate motion data of the target pixel 311 based on characteristics of the target pixel 311 and adjacent pixels and may be configured in multiple sizes. For example, one or more motion masks may include a first mask 312 that generates motion data of the target pixel 311 based on the characteristics of the target pixel 311 and I pixels adjacent to the target pixel 311 (I is a natural number), a second mask 313 that generates motion data of the target pixel 311 based on the characteristics of the target pixel 311 and J pixels adjacent to the target pixel 311 (J is a natural number greater than I), and a third mask 314 that generates motion data of the target pixel 311 based on the characteristics of the target pixel 311 and K pixels adjacent to the target pixel 311 (K is a natural number greater than J). However, the size and/or configuration of such masks are examples, and embodiments are not limited thereto.

According to one or more embodiments, at least one motion mask may generate motion data of a target pixel based on the characteristics of pixels belonging to the corresponding mask. For example, the motion data of the target pixel may reflect the average characteristics of the pixels belonging to the corresponding mask. Characteristics of individual pixels used to generate the motion data may be determined based on various parameters representing characteristics of the pixels. For example, the characteristics may be determined based on brightness, color, etc. of the individual pixels. However, this is an example, and embodiments are not limited thereto.

Below, a process of generating an output image by synthesizing one or more channels by the processor 110 will be mainly described.

The processor 110 according to one or more embodiments may generate motion data for each of one or more pixels included in one or more channels by using one or more motion masks having different sizes.

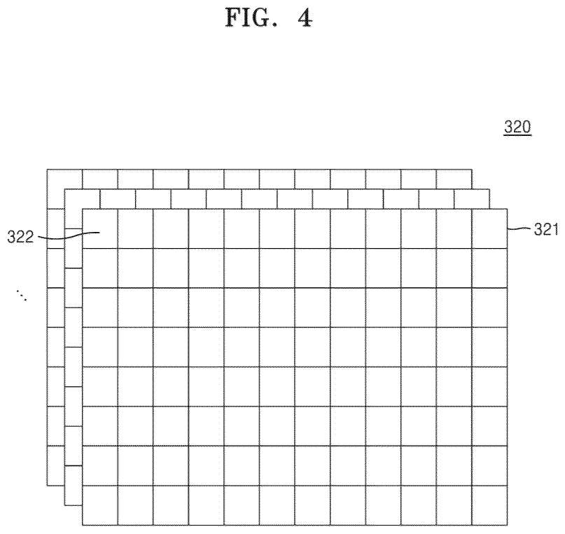

FIG. 4 is a diagram for explaining an example motion data set 320.

As described above, the processor 110 according to one or more embodiments may generate motion data for each of one or more pixels included in one or more channels using one or more motion masks. For example, when there are five types of motion masks and three channels, the processor 110 may generate a total of five motion data sets by applying the five types of motion masks to one channel.

Returning to FIG. 4, the processor 110 may generate a first motion data set 321 by applying a first motion mask to pixels of the first channel. At this time, the motion data included in the first motion data set 321 may be data generated when a motion mask is applied to pixels at positions corresponding to each motion data on the first channel as target pixels. For example, motion data 322 may be data acquired when a motion mask is applied to a pixel at a position corresponding to the motion data 322 on the first channel as a target pixel.

Similarly, the processor 110 may complete the motion data set 320 for the first channel by applying a motion mask, such as a second motion mask and a third motion mask, to the pixels of the first channel.

The processor 110 may also generate a motion data set for each channel by performing the above-described process for each of the second and third channels.

In one or more other embodiments, the processor 110 may generate a motion data set by applying different types of masks to each channel according to preset rules. For example, the processor 110 may generate a motion data set using only the third to fifth motion masks for the first channel, generate a motion data set using only the first to fifth motion masks for the second channel, and generate a motion data set using only the first to third motion masks for the third channel. However, this is an example, and embodiments are not limited thereto.

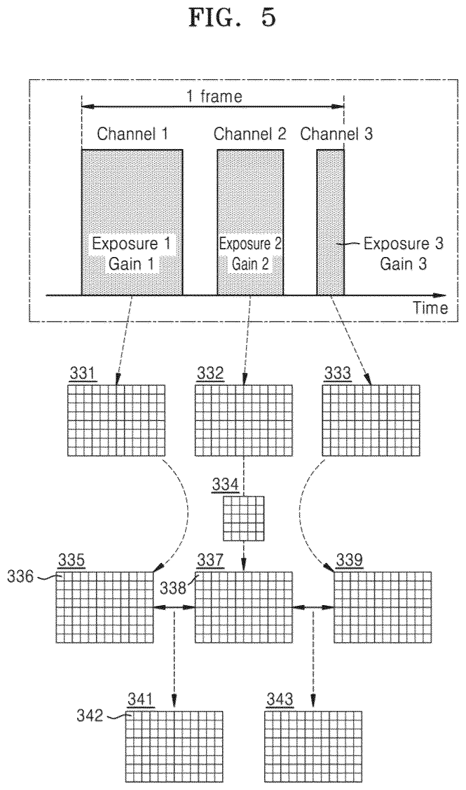

FIG. 5 is a diagram for explaining a process of generating a motion map by the processor 110 according to one or more embodiments. Hereinafter, for the convenience of explanation, only a process in which a single motion mask 334 is applied to three channels (a first channel 331, a second channel 332, and a third channel 333) among the entire image processing process is extracted and explained.

According to the process described above, the processor 110 according to one or more embodiments may generate motion data sets 335, 337, and 339 from each of the first, second, and third channels 331, 332, and 333 using the single motion mask 334.

The processor 110 according to one or more embodiments may generate one or more motion maps based on the difference in motion data between one or more channels for the same-sized motion mask. For example, the processor 110 according to one or more embodiments may generate a motion map including a difference between the motion data according to the first motion mask for the first comparison target channel for each pixel and the motion data according to the first motion mask for the second comparison target channel.

For example, the processor 110 may generate a motion map 341 based on a difference between the motion data set 335 of the first channel 331 generated from the motion mask 334 and the motion data set 337 of the second channel 332 generated from the motion mask 334.

Here, the processor 110 may calculate (obtain) a difference between the motion data set 335 and the motion data set 337 in pixel units and generate the motion map 341 based on the difference. For example, the processor 110 may generate a motion value 342 included in the motion map 341 based on a difference between the motion data 336 of the motion data set 335 and the motion data 338 of the motion data set 337.

Similarly, the processor 110 may generate a motion map 343 based on a difference between the motion data set 337 of the second channel 332 generated from the motion mask 334 and the motion data set 339 of the third channel 333 generated from the motion mask 334.

In addition, the processor 110 may generate one or more motion maps based on the difference between the motion data of one or more channels for different-sized motion masks. A detailed description thereof is omitted.

The processor 110 according to one or more embodiments may determine a motion map to be referenced among one or more motion maps for each pixel included in the output image.

The processor 110 according to one or more embodiments may determine a motion map to be referenced for each pixel based on the exposure size of each of one or more channels, at least one of gain values of one or more channels, and the brightness per pixel of one or more channels.

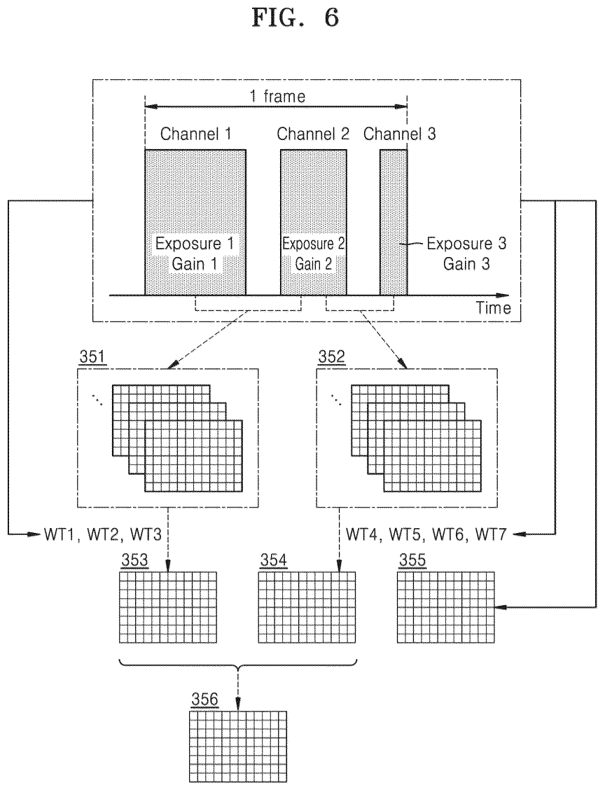

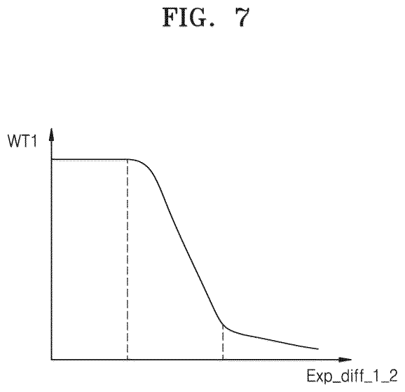

FIG. 6 is a diagram for explaining a process of determining a motion map to be referenced for each pixel included in an output image by the processor 110 according to one or more embodiments. Hereinafter, for convenience of explanation, it is explained on the premise that one or more first motion maps 351 based on a difference in motion data between the first channel and the second channel and one or more second motion maps 352 based on a difference in motion data between the second channel and the third channel are generated through the process described with reference to FIG. 5. Also, it is described with reference to FIGS. 7 to 14 together.

The processor 110 according to one or more embodiments may determine a third motion map 353 to be referenced among one or more first motion maps 351.

To this end, the processor 110 according to one or more embodiments may calculate (obtain) a first weight WT1 based on a difference between the first exposure Exposure 1 and the second exposure Exposure 2 at a position corresponding to the first pixel included in the output image. Here, the first exposure Exposure 1 may be the exposure of the first channel Channel 1, and the second exposure Exposure 2 may be the exposure of the second channel Channel 2.

FIG. 7 is a diagram illustrating a graph used to calculate (obtain) a first weight WT1 by the processor 110 according to one or more embodiments.

According to a graph illustrated in FIG. 7, the processor 110 according to one or more embodiments may calculate (obtain) the first weight WT1 so that the first weight WT1 decreases as the difference Exp_diff_1_2 between the first exposure Exposure 1 and the second exposure Exposure 2 increases.

Therefore, embodiments may consider an exposure difference between channels in selecting a size of the motion mask to be used in the output image, and for example, the smaller the exposure difference between channels, the greater the motion mask is selected, thereby minimizing the occurrence of motion artifacts in an output image.

Then, the processor 110 may calculate (obtain) a second weight WT2 based on a size of the first exposure Exposure 1 at a position corresponding to the first pixel.

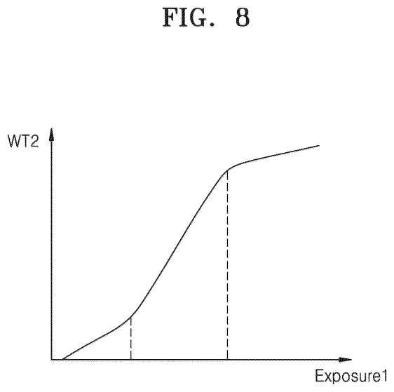

FIG. 8 is a diagram illustrating a graph used to calculate (obtain) the second weight WT2 by the processor 110 according to one or more embodiments.

According to a graph illustrated in FIG. 8, the processor 110 according to one or more embodiments may calculate the second weight WT2 so that the second weight WT2 increases as the size of the first exposure Exposure 1 increases. In this way, embodiments minimize the occurrence of motion artifacts in an output image by considering the fact that, as the size of the first exposure Exposure 1 increases, a difference between the second exposure Exposure 2, which is the exposure of the second channel Channel 2, increases in selecting the size of the motion mask.

The processor 110 according to one or more embodiments may calculate (obtain) a third weight WT3 based on a gain Gain 2 of the second channel Channel 2.

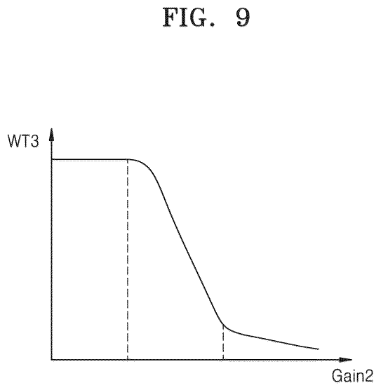

FIG. 9 is a diagram illustrating a graph used to calculate (obtain) a third weight WT3 by the processor 110 according to one or more embodiments.

According to the graph illustrated in FIG. 9, the processor 110 according to one or more embodiments may calculate (obtain) the third weight WT3 so that the third weight WT3 decreases as the gain Gain 2 of the second channel Channel 2 increases.

In this way, embodiments may improve noise in a motion region by using a motion mask of a smaller size in a situation when a gain of the second channel Channel 2 is relatively large.

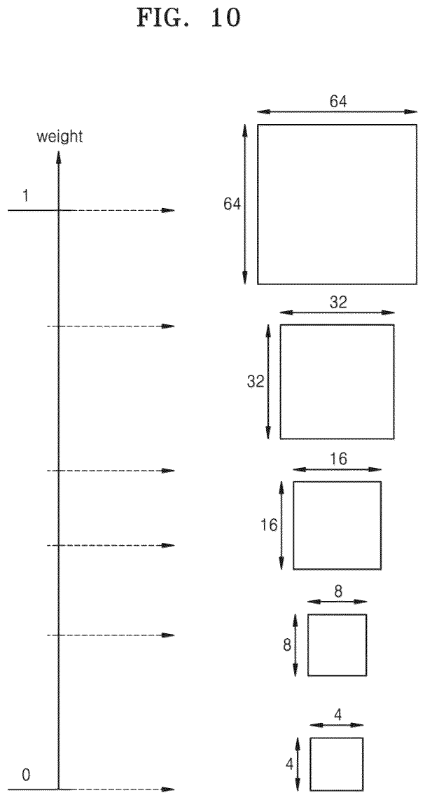

The processor 110 according to one or more embodiments may determine the third motion map 353 based on the first weight WT1, the second weight WT2, and the third weight WT3 calculated (obtained) according to the process described above At this time, the processor 110 may determine the third motion map 353 based on data in which the size of the motion mask used for generating the motion map for each weight, as shown in FIG. 10, is mapped.

For example, the processor 110 may determine the size of the motion mask used for generating the motion map by inputting a final weight calculated (obtained) based on the first weight WT1, the second weight WT2, and the third weight WT3 into mapping data shown in FIG. 10, and determine a motion map generated based on the motion mask of the corresponding size as the third motion map 353.

Referring to FIG. 6, the processor 110 according to one or more embodiments may determine a fourth motion map 354 to be referenced among one or more second motion maps 352.

To this end, the processor 110 according to one or more embodiments may calculate (obtain) a fourth weight WT4 based on a difference Exp_diff_2_3 between the second exposure Exposure 2 and the third exposure Exposure 3 at a position corresponding to the first pixel included in the output image. For example, the second exposure Exposure 2 may be the exposure of the second channel Channel 2, and the third exposure Exposure 3 may be the exposure of the third channel Channel 3.

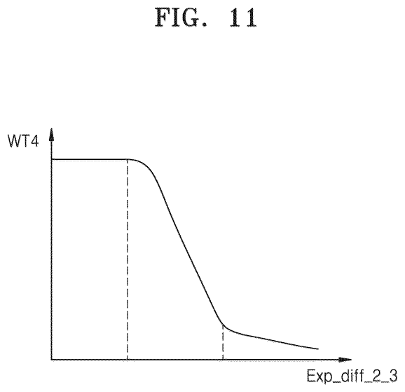

FIG. 11 is a diagram illustrating a graph used to calculate (obtain) a fourth weight WT4 by the processor 110 according to one or more embodiments.

According to the graph illustrated in FIG. 11, the processor 110 according to one or more embodiments may calculate (obtain) the fourth weight WT4 so that the fourth weight WT4 decreases as the difference between the second exposure Exposure 2 and the third exposure Exposure 3 increases.

Therefore, embodiments may consider an exposure difference between channels in selecting the size of the motion mask to be used in an output image, and for example, the smaller the exposure difference between channels, the greater the motion mask is selected, thereby minimizing the occurrence of motion artifacts in the output image.

Then, the processor 110 may calculate (obtain) a fifth weight WT5 based on the size of the second exposure Exposure 2 at the position corresponding to the first pixel.

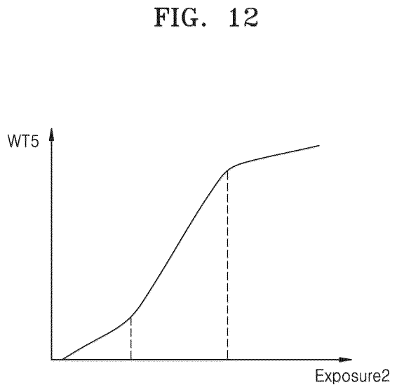

FIG. 12 is a diagram illustrating a graph used to calculate (obtain) a fifth weight WT5 by the processor 110 according to one or more embodiments.

According to the graph illustrated in FIG. 12, the processor 110 according to one or more embodiments may calculate (obtain) the fifth weight WT5 so that the fifth weight WT5 increases as the size of the second exposure Exposure 2 increases.

In this way, embodiments may minimize the occurrence of motion artifacts in the output image by considering the fact that a difference between the third exposure Exposure 3, which is the exposure of the third channel Channel 3, increases as the size of the second exposure Exposure 2 increases in the selection of the size of the motion mask.

The processor 110 according to one or more embodiments may calculate (obtain) a sixth weight WT6 based on a gain Gain 3 of the third channel Channel 3.

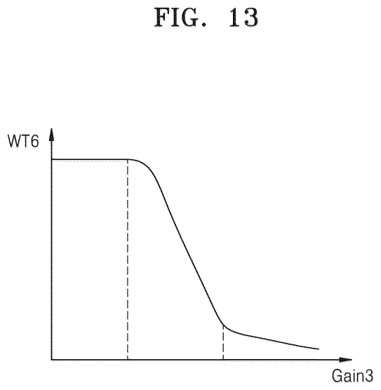

FIG. 13 is a diagram illustrating a graph used to calculate (obtain) a sixth weight WT6 by the processor 110 according to one or more embodiments.

According to the graph illustrated in FIG. 13, the processor 110 according to one or more embodiments may calculate the sixth weight WT6 so that the sixth weight WT6 decreases as the gain Gain 3 of the third channel Channel 3 increases.

In this way, embodiments may improve noise in a motion region by using a motion mask of a smaller size in a state that the gain Gain 3 of the third channel Channel 3 is relatively large.

In addition, the processor 110 may calculate (obtain) a seventh weight WT7 based on a difference between the first exposure Exposure 1 and the second exposure Exposure 2 at a position corresponding to the first pixel included in the output image. For example, the first exposure Exposure 1 may be the exposure of the first channel Channel 1, and the second exposure Exposure 1 may be the exposure of the second channel Channel 2.

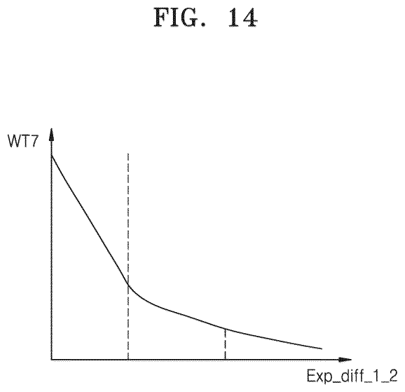

FIG. 14 is a diagram illustrating a graph used to calculate (obtain) a seventh weight WT7 by the processor 110 according to one or more embodiments.

According to the graph illustrated in FIG. 14, the processor 110 according to one or more embodiments may calculate (obtain) the seventh weight WT7 so that the seventh weight WT7 decreases as a difference between the first exposure Exposure 1 and the second exposure Exposure 2 increases.

Therefore, embodiments may consider an exposure difference between channels in selecting the size of a motion mask to be used in an output image, and in particular, the smaller the exposure difference with the channel Channel 1, which is a channel that is a reference for exposure, the larger the motion mask is selected, thereby minimizing the occurrence of motion artifacts in the output image.

Referring to FIG. 6, the processor 110 according to one or more embodiments may determine the fourth motion map 354 based on the fourth weight WT4, the fifth weight WT5, the sixth weight WT6, and the seventh weight WT7 calculated (obtained) according to the process described above. At this time, the processor 110 may determine the third motion map 354 based on data in which the sizes of the motion masks used for generating the motion maps for each weight, as illustrated in FIG. 10, are mapped.

For example, the processor 110 (FIG. 1) may determine the sizes of the motion masks used for generating the motion maps by inputting a final weight calculated (obtained) based on the fourth weight WT4, the fifth weight WT5, the sixth weight WT6, and the seventh weight WT7 into the mapping data illustrated in FIG. 10 and determine a motion map generated based on the motion mask of the corresponding sizes as the fourth motion map 354.

The processor 110 according to one or more embodiments may determine one of the third motion map 353 and the fourth motion map 354 as a motion map to be referenced for the first pixel based on the brightness 355 of each pixel of one or more channels.

For example, the processor 110 according to one or more embodiments may determine the third motion map 353 as the motion map 356 to be referenced when the brightness of the first pixel is below a predetermined threshold value and may determine the fourth motion map 354 as the motion map 356 to be referenced when the brightness of the first pixel exceeds the predetermined threshold value.

The processor 110 according to one or more embodiments may determine a motion map to be referenced for each pixel by performing the processes described above for individual pixels included in the output image.

The processor 110 according to one or more embodiments may determine a composition ratio of the one or more channels to be used for each pixel included in an output image based on a motion value on the motion map to be referenced determined according to the process described above. In addition, the processor 110 according to one or more embodiments may generate an output image according to the determined composition ratio of one or more channels.

For example, the processor 110 according to one or more embodiments may determine the composition ratio of one or more channels for each pixel of the output image based on data in which the composition ratio of each channel is mapped according to each motion value.

In this case, the mapping data may be configured to use only the first channel for a motion minimum value, only the second channel for a motion median value, and only the third channel for a motion maximum value. In addition, the composition ratio may be configured to appropriately mix and use the first and second channels for values between the motion minimum value and the motion median value, and similarly, the composition ratio may be configured to appropriately mix and use the second and third channels for values between the motion median value and the motion maximum value. However, such a configuration is an example, and embodiments are not limited thereto.

In addition, the processor 110 may generate an output image by merging one or more channels according to the composition ratio.

Accordingly, embodiments may more effectively reduce noise in a motion region while minimizing motion artifacts in an image in which multiple channels are merged.

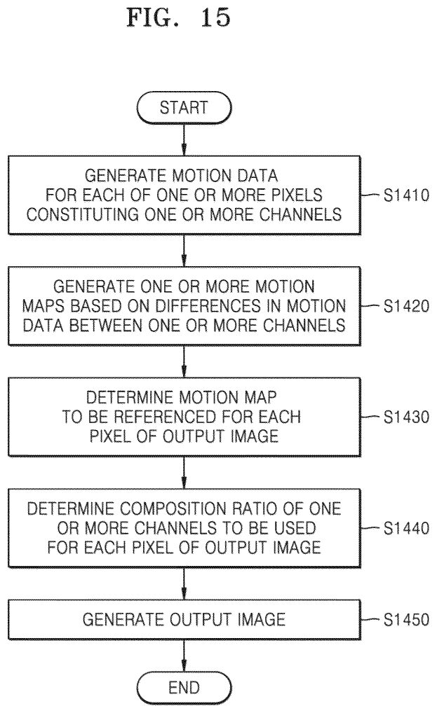

FIG. 15 is a flowchart for explaining an image processing method performed by the processor 110 according to one or more embodiments. The following description is made with reference to FIGS. 1 to 14, but descriptions previously given above are omitted.

The processor 110 according to one or more embodiments may generate motion data for each of one or more pixels included in one or more channels by using one or more motion masks having different sizes. (S1410)

FIG. 4 is a diagram for explaining an example motion data set 320.

As described above, the processor 110 according to one or more embodiments may generate motion data for each of one or more pixels included in one or more channels by using one or more motion masks. For example, when there are five types of motion masks and three channels, the processor 110 may apply five types of motion masks to one channel to generate a total of five motion data sets.

Referring to FIG. 4 again, the processor 110 may generate a first motion data set 321 by applying a first motion mask to pixels of the first channel. At this time, the motion data included in the first motion data set 321 may be data generated when a motion mask is applied to pixels at positions corresponding to each motion data on the first channel as target pixels. For example, the motion data 322 may be data acquired when a motion mask is applied to pixels at positions corresponding to the motion data 322 on the first channel as target pixels.

Similarly, the processor 110 may complete the motion data set 32) for the first channel by applying motion masks such as the second motion mask and the third motion mask to the pixels of the first channel.

The processor 110 may generate a motion data set for each channel by performing the process described above for each of the second channel and the third channel.

In one or more other embodiments, the processor 110 may generate a motion data set by applying different types of masks to each channel according to preset rules. For example, the processor 110 may generate a motion data set using only the third to fifth motion masks for the first channel, generate a motion data set using only the first to fifth motion masks for the second channel, and generate a motion data set using only the first to third motion masks for the third channel. However, this is an example and embodiments are not limited thereto.

The processor 110 according to one or more embodiments may generate one or more motion maps based on a difference in motion data between one or more channels for motion masks of the same size. (S1420)

For example, the processor 110 according to one or more embodiments may generate a motion map including the difference between motion data according to the first motion mask for a first comparison target channel for each pixel and motion data according to the first motion mask for the second comparison target channel.

FIG. 5 is a diagram for explaining a process of generating a motion map by the processor 110 according to one or more embodiments. Hereinafter, for convenience of explanation, only the process in which a single motion mask 334 is applied to three channels (a first channel 331, a second channel 332, and a third channel 333) during the entire image processing process is extracted and explained.

According to the process described above, the processor 110 according to one or more embodiments may generate motion data sets 335, 337, and 339 from each of the first, second, and third channels 331, 332, and 333 using the motion mask 334.

At this time, the processor 110 according to one or more embodiments may generate a motion map 341 based on a difference between the motion data set 335 of the first channel 331 generated from the motion mask 334 and the motion data set 337 of the second channel 332 generated from the motion mask 334.

Here, the processor 110 may calculate (obtain) a difference between the motion data set 335 and the motion data set 337 in pixel units and generate the motion map 341 based on the difference. For example, the processor 110 may generate a motion value 342 included in the motion map 341 based on the difference between the motion data 336 of the motion data set 335 and the motion data 338 of the motion data set 337.

Similarly, the processor 110 may generate a motion map 343 based on a difference between the motion data set 337 of the second channel 332 generated from the motion mask 334 and the motion data set 339 of the third channel 333 generated from the motion mask 334.

In addition, the processor 110 may generate one or more motion maps based on a difference between the motion data of one or more channels for different-sized motion masks. A detailed description thereof is omitted.

The processor 110 according to one or more embodiments may determine a motion map to be referenced among one or more motion maps for each pixel included in an output image. (S1430)

The processor 110 according to one or more embodiments may determine a motion map to be referenced for each pixel based on the exposure size of each of one or more channels, at least one of gain values of one or more channels, and the brightness per pixel of one or more channels.

FIG. 6 is a diagram for explaining a process of determining a motion map to be referenced for each pixel included in an output image by the processor 110 according to one or more embodiments. Hereinafter, for convenience of explanation, it is explained on the premise that one or more first motion maps 351 based on the difference in motion data between the first channel and the second channel and one or more second motion maps 352 based on the difference in motion data between the second channel and the third channel are generated through the process described with reference to FIG. 5. Also, it is described with reference to FIGS. 7 to 14 together.

The processor 110 according to one or more embodiments may determine the third motion map 353 to be referenced among one or more first motion maps 351.

To this end, the processor 110 according to one or more embodiments may calculate (obtain) the first weight WT1 based on the difference between the first exposure Exposure 1 and the second exposure Exposure 2 at a position corresponding to the first pixel included in an output image. For example, the first exposure Exposure 1 may be the exposure of the first channel Channel 1, and the second exposure Exposure 1 may be the exposure of the second channel Channel 2.

FIG. 7 is a diagram illustrating a graph used to calculate (obtain) a first weight WT1 by the processor 110 according to one or more embodiments.

According to the graph illustrated in FIG. 7, the processor 110 according to one or more embodiments may calculate (obtain) the first weight WT1 so that the first weight WT1 decreases as the difference Exp_diff_1_2 between the first exposure Exposure 1 and the second exposure Exposure 2 increases.

Therefore, embodiments may consider the exposure difference between channels in selecting the size of the motion mask to be used in an output image, and in particular, the smaller the exposure difference between channels, the greater the motion mask is selected, thereby minimizing the occurrence of motion artifacts in the output image.

Then, the processor 110 may calculate (obtain) the second weight WT2 based on the size of the first exposure Exposure 1 at a position corresponding to the first pixel.

FIG. 8 is a diagram illustrating a graph used to calculate (obtain) a second weight WT2 by the processor 110 according to one or more embodiments.

According to the graph illustrated in FIG. 8, the processor 110 according to one or more embodiments may calculate (obtain) the second weight WT2 so that the second weight WT2 increases as the size of the first exposure Exposure 1 increases. In this way, embodiments may minimize the occurrence of motion artifacts in an output image by considering the fact that, as the size of the first exposure Exposure 1 increases, a difference between the second exposure Exposure 1, which is the exposure of the second channel Channel 2, and the first exposure Exposure 1 increases in selecting the size of the motion mask.

The processor 110 according to one or more embodiments may calculate (obtain) the third weight WT3 based on the gain Gain 2 of the second channel Channel 2.

FIG. 9 is a diagram illustrating a graph used to calculate (obtain) a third weight WT3 by the processor 110 according to one or more embodiments.

According to the graph illustrated in FIG. 9, the processor 110 according to one or more embodiments may calculate (obtain) the third weight WT3 so that the third weight WT3 decreases as the gain Gain 2 of the second channel Channel 2 increases.

In this way, embodiments may improve noise in a motion region by using a motion mask of a smaller size when the gain of the second channel Channel 2 is relatively large.

The processor 110 according to one or more embodiments may determine the third motion map 353 based on the first weight WT1, the second weight WT2, and the third weight WT3 calculated (obtained) according to the process described above. At this time, the processor 110 may determine the third motion map 353 based on data to which the size of the motion mask used for generating a motion map for each weight, as illustrated in FIG. 10, is mapped.

For example, the processor 110 may determine the size of the motion mask used for generating a motion map by inputting a final weight calculated (obtained) based on the first weight WT1, the second weight WT2, and the third weight WT3 into the mapping data illustrated in FIG. 10 and determine the motion map generated based on the motion mask of the corresponding size as the third motion map 353.

Referring to FIG. 6 again, the processor 110 according to one or more embodiments may determine the fourth motion map 354 to be referenced among one or more second motion maps 352.

To this end, the processor 110 according to one or more embodiments may calculate (obtain) the fourth weight WT4 based on a difference Exp_diff_2_3 between the second exposure Exposure 2 and the third exposure Exposure 3 at a position corresponding to the first pixel included in an output image. For example, the second exposure Exposure 2 may be the exposure of the second channel Channel 2, and the third exposure Exposure 3 may be the exposure of the third channel Channel 3.

FIG. 11 is a diagram illustrating a graph used to calculate (obtain) a fourth weight WT4 by the processor 110 according to one or more embodiments.

According to the graph illustrated in FIG. 11, the processor 110 according to one or more embodiments may calculate (obtain) the fourth weight WT4 so that the fourth weight WT4 decreases as the difference between the second exposure Exposure 2 and the third exposure Exposure 3 increases.

Accordingly, embodiments may consider the exposure difference between channels in selecting the size of a motion mask to be used in an output image, and in particular, the smaller the exposure difference between channels, the greater the motion mask is selected, thereby minimizing the occurrence of motion artifacts in the output image.

Next, the processor 110 may calculate (obtain) the fifth weight WT5 based on the size of the second exposure Exposure 2 at the position corresponding to the first pixel.

FIG. 12 is a diagram illustrating a graph used to calculate (obtain) a fifth weight WT5 by the processor 110 according to one or more embodiments.

According to the graph illustrated in FIG. 12, the processor 110 according to one or more embodiments may calculate (obtain) the fifth weight WT5 so that the fifth weight WT5 increases as the size of the second exposure Exposure 2 increases.

In this way, embodiments may minimize the occurrence of motion artifacts in an output image by considering the fact that, as the size of the second exposure Exposure 2 increases, a difference between the third exposure Exposure 3, which is the exposure of the third channel Channel 3, increases in selecting the size of the motion mask.

The processor 110 according to one or more embodiments may calculate (obtain) the sixth weight WT6 based on the gain Gain 3 of the third channel Channel 3.

FIG. 13 is a diagram illustrating a graph used to calculate (obtain) the sixth weight WT6 by the processor 110 according to one or more embodiments.

According to the graph illustrated in FIG. 13, the processor 110 according to one or more embodiments may calculate (obtain) the sixth weight WT6 so that the sixth weight WT6 decreases as the gain Gain 3 of the third channel Channel 3 increases.

In this way, embodiments may improve noise in a motion region by using a motion mask of a smaller size when the gain Gain 3 of the third channel Channel 3 is relatively large.

In addition, the processor 110 may calculate (obtain) the seventh weight WT7 based on a difference between the first exposure Exposure 1 and the second exposure Exposure 2 at a position corresponding to the first pixel included in an output image. For example, the first exposure Exposure 1 may be the exposure of the first channel Channel 1, and the second exposure Exposure 1 may be the exposure of the second channel Channel 2.

FIG. 14 is a diagram illustrating a graph used to calculate (obtain) the seventh weight WT7 by the processor 110 according to one or more embodiments.

According to the graph illustrated in FIG. 14, the processor 110 according to one or more embodiments may calculate (obtain) the seventh weight WT7 so that the seventh weight WT7 decreases as a difference between the first exposure Exposure 1 and the second exposure Exposure 2 increases.

Accordingly, embodiments may consider the exposure difference between channels in selecting the size of the motion mask to be used in the output image, and in particular, the smaller the exposure difference from Channel 1, which is the channel that serves as the exposure reference, the greater the motion mask is selected, thereby minimizing the occurrence of motion artifacts in the output image.

Referring to FIG. 6 again, the processor 110 according to one or more embodiments may determine the fourth motion map 354 based on the fourth weight WT4, the fifth weight WT5, the sixth weight WT6, and the seventh weight WT7 calculated (obtained) according to the process described above. At this time, the processor 110 may determine the third motion map 354 based on data to which the size of the motion mask used for generating a motion map for each weight, as illustrated in FIG. 10, is mapped.

For example, the processor 110 (FIG. 1) may determine the size of the motion mask used for generating the motion map by inputting a final weight calculated based on the fourth weight WT4, the fifth weight WT5, the sixth weight WT6, and the seventh weight WT7 into the mapping data illustrated in FIG. 10 and may determine the motion map generated based on the motion mask of the corresponding size as the fourth motion map 354.

The processor 110 according to one or more embodiments may determine one of the third motion map 353 and the fourth motion map 354 as a motion map to be referenced for the first pixel based on brightness 355 of each pixel of one or more channels.

For example, the processor 110 according to one or more embodiments may determine the third motion map 353 as the motion map 356 to be referenced when the brightness of the first pixel is below a predetermined threshold value and may determine the fourth motion map 354 as the motion map 356 to be referenced when the brightness of the first pixel exceeds the predetermined threshold value.

The processor 110 according to one or more embodiments may perform the processes described above for each individual pixel included in an output image to determine a motion map to be referenced for each pixel.

The processor 110 according to one or more embodiments may determine the composition ratio of the one or more channels to be used for each pixel included in an output image based on a motion value on the motion map to be referenced determined according to the process described above. (S1440)

For example, the processor 110 according to one or more embodiments may determine a composition ratio of the one or more channels for each pixel of an output image based on data in which the composition ratio of each channel is mapped according to each motion value.

The mapping data may be configured to use only the first channel for a motion minimum value, only the second channel for a motion median value, and only the third channel for a motion maximum value. In addition, for values between the motion minimum value and the motion median value, the configuration ratio may be configured to appropriately mix and use the first channel and the second channel according to the value, and similarly, for values between the motion median value and the motion maximum value, the configuration ratio may be configured to appropriately mix and use the second channel and the third channel according to the value. However, such a configuration is an example and embodiments are not limited thereto.

In addition, the processor 110 may generate an output image by merging one or more channels according to the configuration ratio.

Accordingly, embodiments may more effectively reduce noise in a motion region while minimizing motion artifacts in an image in which multiple channels are merged.

A shooting method according to one or more embodiments may further include a process of acquiring images of one or more channels having different exposure sizes before performing the operation S1410. The acquired images of one or more channels may be used to generate an output image through the aforementioned operations S1410 to S1450. The shooting method may be performed by a shooting apparatus.

According to one or more embodiments, it is possible to more effectively reduce noise in a motion region while minimizing motion artifacts in an image generated by merging one or more channels.

One or more embodiments may be implemented in the form of a computer program that may be executed through various components on a computer, and such a computer program may be recorded on a non-transitory computer-readable recording medium. At this time, the non-transitory computer-readable recording medium may include a magnetic medium such as a hard disk, a floppy disk, and a magnetic tape, an optical recording medium such as a CD-ROM and a DVD, a magneto-optical medium such as a floptical disk, and a hardware device specifically configured to store and execute program instructions such as a ROM, a RAM, a flash memory, etc. In addition, the medium may include an intangible medium implemented in a form that may be transmitted over a network, and may be a medium in a form that may be transmitted and distributed over a network, for example, implemented in the form of software or an application.

The computer program may be one that is specifically designed and configured for the present disclosure or one that is known and available to those skilled in the art of computer software. Examples of computer programs may include not only machine language codes created by a compiler, but also high-level language codes that may be executed by a computer using an interpreter, etc.

The specific implementations described in the present disclosure are example embodiments and do not limit the scope of the present disclosure in any way. For brevity of the specification, descriptions of conventional electronic components, control systems, software, and other functional aspects of the systems may be omitted. In addition, connections or connection members of lines between components shown in the drawings illustrate functional connections and/or physical or circuit connections, and the connections or connection members can be represented by replaceable or additional various functional connections, physical connections, or circuit connections in an actual apparatus.

Therefore, embodiments should not be limited to the embodiments described above, and not only the scope of the patent claims described below, but also all scopes equivalent to or equivalently modified from the scope of the patent claims are considered to belong to the scope of the idea of embodiments.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope of the disclosure as defined by the following claims and their equivalents.

What is claimed is:

1. An image processing method comprising:
generating motion data for a pixel included in each of one or more channels configured to use motion masks having different sizes, the channels being included in at least a portion of an output image;
generating one or more motion maps based on a difference in motion data between the one or more channels for motion masks having a same size;
determining a reference motion map among the one or more motion maps for each pixel included in the output image;
determining a composition ratio of the one or more channels to be used for each pixel included in the output image based on a motion value on the reference motion map; and
generating the output image based on the composition ratio of the one or more channels.

2. The image processing method of claim 1, wherein the one or more channels comprise:
a first channel acquired based on a first exposure for a first scene;
a second channel acquired based on a second exposure for the first scene; and
a third channel acquired based on a third exposure for the first scene,
wherein a size of the second exposure is less than a size of the first exposure, and a size of the third exposure is less than the size of the second exposure.

3. The image processing method of claim 1, wherein the motion masks comprise:
a first mask configured to generate motion data of a target pixel based on characteristics of the target pixel and I pixels adjacent to the target pixel, where I is a natural number; and
a second mask configured to generate motion data of the target pixel based on the characteristics of the target pixel and J pixels adjacent to the target pixel, where J is a natural number greater than I.

4. The image processing method of claim 1, wherein the generating the one or more motion maps comprises:
generating a motion map comprising a difference between motion data based on a first motion mask for a first comparison target channel per pixel and motion data based on the first motion mask for a second comparison target channel.

5. The image processing method of claim 1, wherein the one or more channels comprise:
a first channel obtained based on a first exposure for a first scene;
a second channel obtained based on a second exposure for the first scene; and
a third channel obtained based on a third exposure for the first scene,
wherein a size of the second exposure is less than a size of the first exposure, and a size of the third exposure is less than the size of the second exposure, and
wherein the determining the reference motion map comprises determining the reference motion map based on at least one of the size of the first exposure of the first channel, the size of the second exposure of the second channel, the size of the third exposure of the third channel, a gain value of the first channel, a gain value of the second channel, a gain value of the third channel, a brightness per pixel of the first channel, a brightness per pixel of the second channel, and a brightness per pixel of the third channel.

6. The image processing method of claim 5, wherein the determining the reference motion map comprises:
determining a third reference motion map among one or more first motion maps generated based on a difference in motion data of the first channel and motion data of the second channel;
determining a fourth reference motion map among one or more second motion maps generated based on a difference in motion data of the second channel and motion data of the third channel; and
determining one of the third reference motion map and the fourth reference motion map as the reference motion map based on the brightness per pixel of the one or more channels.

7. The image processing method of claim 6, wherein the determining the third reference motion map comprises:
obtaining a first weight based on a difference between the first exposure and the second exposure at a position corresponding to a first pixel included in the output image;
obtaining a second weight based on a size of the first exposure at the position corresponding to the first pixel;
obtaining a third weight based on a gain of the second channel; and
determining the third reference motion map based on the first weight, the second weight, and the third weight,
wherein the determining of the third reference motion map comprises determining the third reference motion map based on data in which a size of a motion mask used for generating a motion map is mapped for each weight.

8. The image processing method of claim 6, wherein the determining the fourth reference motion map comprises:
obtaining a fourth weight based on a difference between the second exposure and the third exposure at a position corresponding to a first pixel included in the output image;
obtaining a fifth weight based on the size of the second exposure at the position corresponding to the first pixel;
obtaining a sixth weight based on a gain of the third channel;
obtaining a seventh weight based on a difference between the first exposure and the second exposure at the position corresponding to the first pixel; and
determining the fourth reference motion map based on the fourth weight, the fifth weight, the sixth weight, and the seventh weight,
wherein the determining of the fourth reference motion map comprise data in which a size of a motion mask used for generating a motion map is mapped for each weight.

9. The image processing method of claim 6, wherein the determining one of the third reference motion map and the fourth reference motion map as the reference motion map comprises:
determining the third reference motion map as the reference motion map based on the brightness of a first pixel being less than a predetermined threshold value, and determining the fourth reference motion map as the reference motion map based on the brightness of the first pixel is greater than the predetermined threshold value.

10. The image processing method of claim 1, wherein the determining the composition ratio comprises:
determining the composition ratio of the channels for each pixel included in the output image based on data in which the composition ratio of each channel among the one or more channels is mapped for each motion value, and
wherein the generating the output image comprises generating the output image by merging the one or more channels based on the composition ratio.

11. An image shooting method for expanding a dynamic range by partial synthesis of one or more channels, the image shooting method comprising:
obtaining images of the one or more channels having different exposure sizes;
generating motion data for a pixel included in each of the one or more channels configured to use motion masks having different sizes, the one or more channels being included in at least a portion of an output image;
generating one or more motion maps based on a difference in motion data between the one or more channels for motion masks having a same size;
determining a reference motion map among the one or more motion maps for each pixel included in the output image;
determining a composition ratio of the one or more channels to be used for each pixel included in the output image based on a motion value on the reference motion map; and
generating the output image based on the composition ratio of the one or more channels.

12. An image processing apparatus comprising:
a memory storing computer code or instructions; and
a processor, when executing the computer code or instructions, configured to:
generate motion data for a pixel included in one or more channels configured to use motion masks having different sizes, the one or more channels being included in at least a portion of an output image;
generate one or more motion maps based on a difference in motion data between the one or more channels for motion masks having a same size;
determine a reference motion map among the one or more motion maps for each pixel included in the output image;
determine a composition ratio of the one or more channels to be used for each pixel included in the output image based on a motion value on the reference motion map; and
generate the output image based on the composition ratio of the one or more channels.

13. The image processing apparatus of claim 12, wherein the one or more channels comprise:
a first channel obtained based on a first exposure for a first scene;
a second channel obtained based on a second exposure for the first scene; and
a third channel obtained based on a third exposure for the first scene,
wherein a size of the second exposure is less than a size of the first exposure, and a size of the third exposure is less than the size of the second exposure.

14. The image processing apparatus of claim 12, wherein the motion masks comprise:
a first mask configured to generate motion data of a target pixel based on characteristics of the target pixel and I pixels adjacent to the target pixel, where I is a natural number; and
a second mask configured to generate motion data of the target pixel based on the characteristics of the target pixel and J pixels adjacent to the target pixel, where J is a natural number greater than I.

15. The image processing apparatus of claim 12, wherein the processor is further configured to, in generating the one or more motion maps, generate a motion map comprising a difference between motion data based on a first motion mask for a first comparison target channel and motion data based on the first motion mask for a second comparison target channel per pixel.

16. The image processing apparatus of claim 12, wherein the one or more channels comprise:
a first channel obtained based on a first exposure for a first scene;
a second channel obtained based on a second exposure for the first scene; and
a third channel obtained based on a third exposure for the first scene,
wherein a size of the second exposure is less than a size of the first exposure, and a size of the third exposure is less than the size of the second exposure, and
wherein the processor is further configured to, in determining a motion map to be referenced, determine the reference motion map among the one or more motion maps based on at least one of the size of the first exposure of the first channel, the size of the second exposure of the second channel, the size of the third exposure of the third channel, a gain value of the first channel, a gain value of the second channel, a gain value of the third channel, a brightness per pixel of the first channel, a brightness per pixel of the second channel, and a brightness per pixel of the third channel.

17. The image processing apparatus of claim 16, wherein the processor, in determining the reference motion map, is further configured to:
determine a third reference motion map among one or more first motion maps generated based on a difference in motion data of the first channel and motion data of the second channel;
determine a fourth reference motion map among one or more second motion maps generated based on a difference in motion data of the second channel and motion data of the third channel; and
determine one of the third reference motion map and the fourth reference motion map as the reference motion map based on the brightness per pixel of the one or more channels.

18. The image processing apparatus of claim 17, wherein the processor, in determining the third reference motion map, is further configured to:
obtain a first weight based on a difference between the first exposure and the second exposure at a position corresponding to a first pixel included in the output image;
obtain a second weight based on the size of the first exposure at the position corresponding to the first pixel;
obtain a third weight based on a gain of the second channel; and
determine the third reference motion map based on the first weight, the second weight, and the third weight,
wherein the third reference motion map is determined based on data in which a size of a motion mask used for generating the motion map is mapped for each weight.

19. The image processing apparatus of claim 17, wherein the processor, in determining the fourth reference motion map, is further configured to:
obtain a fourth weight based on a difference between the second exposure and the third exposure at a position corresponding to a first pixel included in the output image;
obtain a fifth weight based on the size of the second exposure at the position corresponding to the first pixel;
obtain a sixth weight based on a gain of the third channel;
obtain a seventh weight based on the difference between the first exposure and the second exposure at the position corresponding to the first pixel; and
determine the fourth reference motion map based on the fourth weight, the fifth weight, the sixth weight, and the seventh weight,
wherein the fourth reference motion map is determined based on data in which a size of a motion mask used for generating the motion map is mapped for each weight.

20. The image processing apparatus of claim 17, wherein the processor is further configured to determine the third reference motion map as the reference motion map when the brightness of a first pixel is less than a predetermined threshold value and determine the fourth reference motion map as the reference motion map when the brightness of the first pixel is greater than the predetermined threshold value.

21. The image processing apparatus of claim 12, wherein the processor is further configured to determine the composition ratio of the channels for each pixel of the output image based on data in which the composition ratio of each channel is mapped to each motion value and generate the output image by merging the one or more channels based on the composition ratio.

22. An image shooting apparatus configured to expand a dynamic range by partial synthesis of one or more channels, the image shooting apparatus being configured to:
obtain images of the channels having different exposure sizes;
generate motion data for a pixel included in each of the one or more channels configured to use motion masks having different sizes, the channels being included in at least a portion of an output image;
generate one or more motion maps based on a difference in motion data between the one or more channels for motion masks of a same size;
determine a reference motion map among the one or more motion maps for each pixel included in the output image;
determine a composition ratio of the one or more channels to be used for each pixel included in the output image based on a motion value on the reference motion map; and
generate the output image based on the composition ratio of the one or more channels.
